(19) United States
(12) Patent Application Publication
(10) Pub. No.: US 2005/0234896 A1
(43) Pub. Date: Oct. 20, 2005

(54) Image retrieving apparatus, image retrieving method and image retrieving program

(76) Inventors: Nobuyuki Shima, Hachioji-shi (JP); Toshiaki Emori, Fuchu-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/103,979

(22) Filed: Apr. 12, 2005

(30) Foreign Application Priority Data
Apr. 16, 2004 (JP) 2004-121824
Jun. 17, 2004 (JP) 2004-179567

(51) Int. Cl. G06F 17/30

(52) U.S. Cl. 707/3

(57) ABSTRACT

There is disclosed an image retrieving method of an image retrieving apparatus which has an image memory to store image data of an image photographed by a photographing device and photographic information of the image, and retrieves desired image data from the image memory, includes selecting a plurality of image data from the image memory, classifying the photographic information corresponding to the selected image data in accordance with a predetermined classification standard, classifying the image data stored in the image memory based on the photographic information classified by the classification standard, adding keywords to the classified image data, and retrieving desired image data based on the added keywords.

### CROSS-REFERENCE TO RELATED APPLICATIONS

This application is based upon and claims the benefit of priority from prior Japanese Patent Applications No. 2004-121824, filed Apr. 16, 2004; and No. 2004-179567, filed Jun. 17, 2004, the entire contents of both of which are incorporated herein by reference.

### BACKGROUND OF THE INVENTION

1. Field of the Invention

The present invention relates to an image retrieving technology, and more particularly to a technology of retrieving desired images including an image to which no keyword is added.

2. Description of the Related Art

As a method of designating a retrieval key in conventional image retrieval, there has been known a method of adding keywords to images and extracting an image as a result of text-retrieving based on the keywords.

In the case of performing image retrieval by using a plurality of keywords, a technology has been disclosed which classifies keywords into groups by meanings and sets priorities to make image retrieval processing efficient (Jpn. Pat. Appln. KOKAI Publication No. 2000-29901).

According to a technology disclosed in Jpn. Pat. Appln. KOKAI. Publication No. 8-16651, a first keyword is created by using at least one of an input date and a name of image data. Further, a second keyword is generated by referring to information regarding the first keyword. By using these first and second keywords, it is possible to add keywords easily understood by an operator.

Additionally, there has been proposed a technology of using a directory structured to enable quick retrieval (Jpn. Pat. Appln. KOKAI Publication No. 2000-276484).

### BRIEF SUMMARY OF THE INVENTION

A first aspect of the present invention is directed to an image retrieving apparatus includes
an image memory which stores image data of an image photographed by a photographing device and photographic information of the image, an image selection unit which selects image data from the image memory, a photographic information classification unit which classifies the photographic information corresponding to the image data selected by the image selection unit in accordance with a predetermined classification standard, an image classification unit which classifies the image data stored in the image memory based on the photographic information classified by the photographic information classification unit, a keyword addition unit which adds keyword to the image data classified by the image classification unit, and a retrieval unit which retrieves desired image data based on the keywords added by the keyword addition unit.

A second aspect of the present invention is directed to an image retrieving method of an image retrieving apparatus which has an image memory to store image data of an image photographed by a photographing device and photographic information of the image, and retrieves desired image data from the image memory, includes selecting a plurality of image data from the image memory, classifying the photographic information corresponding to the selected image data in accordance with a predetermined classification standard, classifying the image data stored in the image memory based on the photographic information classified by the classification standard, adding keywords to the classified image data, and retrieving desired image data based on the added keywords.

A third aspect of the present invention is directed to a program executed in an image retrieving apparatus which has an image memory to store image data of an image photographed by a photographing device and photographic information of the image data, and retrieves desired image data from the image memory, causing a computer to execute, an image selection step of selecting a plurality of image data from the image memory, a photographic information classification step of classifying the photographic information corresponding to the image data selected in the image selection step in accordance with a predetermined classification standard, an image classification step of classifying the image data stored in the image memory based on the photographic information classified in the photographic information classification step, a keyword addition step of adding keywords to the image data classified in the image classification step, and a retrieval step of retrieving the image data based on the keywords added in the keyword addition step.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a structure of an image retrieval screen by an image retrieving method according to a first embodiment of the present invention;

FIG. 2 is a diagram showing an image retrieval screen when a calendar tab is selected;

FIG. 3 is a diagram showing an image retrieval screen when an Exif tag tab is selected;

FIG. 4 is a diagram showing a configuration of an image retrieving apparatus;

FIG. 5 is a flowchart showing a rough image retrieving process;

FIG. 6 is a flowchart showing a process of registering an image in an image management DB;

FIG. 7 is a diagram showing a structure of a registration record;

FIG. 8 is a table showing accessory information of an image file of an Exif form;

FIG. 9A is a database showing contents of a representative Exif tag;

FIG. 9B is a database showing contents of a representative Exif tag;

FIG. 10 is a flowchart showing a folder displaying process;

FIG. 11 is a flowchart showing a folder displaying process;

FIG. 12 is a flowchart showing a keyword retrieval displaying process;

FIG. 13 is a flowchart showing a keyword deleting process;

FIG. 14 is a flowchart showing a calendar displaying process;

FIG. 15 is a flowchart showing a calendar displaying process;

FIG. 16 is a flowchart showing an Exif tag displaying process;

FIG. 17 is a flowchart showing an Exif tag displaying process;

FIG. 18 is a flowchart showing an Exif tag contents displaying process;

FIG. 19 is a diagram showing an image retrieval screen when a folder tab is selected;

FIG. 20 is a diagram showing an image retrieval screen when a calendar tab is selected;

FIG. 21 is a diagram showing an image retrieval screen when an Exif tag tab is selected;

FIG. 22 is a graph explaining a principle of image classification and retrieval;

FIG. 23 is a diagram showing a configuration of an image retrieving apparatus to which the image retrieving method of the embodiment of the invention is applied;

FIG. 24 is a flowchart showing a rough registration process in a keyword storing unit;

FIG. 25 is a flowchart showing a rough similarity analyzing process;

FIG. 26 is a graph showing a distribution range of one variable;

FIG. 27 is a diagram showing a structure of the keyword storing unit;

FIG. 28 is a flowchart showing a rough registration process in a management data storing unit;

FIG. 29 is a diagram showing a structure of the management data storing unit;

FIG. 30 is a flowchart showing a rough additional registration process in the management data storing unit;

FIG. 31 is a flowchart showing a rough image retrieving process based on a keyword; and

FIG. 32 is a flowchart showing a rough image retrieving process based on an image.

### DETAILED DESCRIPTION OF THE INVENTION

### First Embodiment

According to an image retrieving method of an embodiment of the present invention, a user executes management and retrieval of images based on an image retrieval screen displayed on a display unit of an image retrieving apparatus.

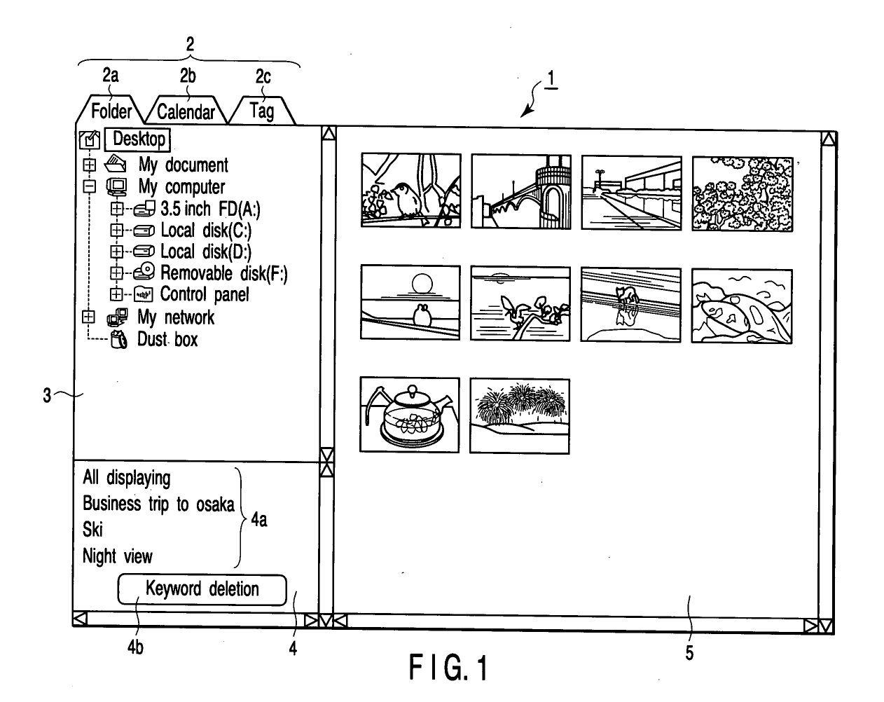

A structure of an image retrieval screen of an image retrieving method according to a first embodiment of the present invention will be described by referring to FIG. 1.

An image retrieval screen 1 comprises a switching tab 2, a browse area 3, a keyword area 4, and a thumbnail area 5. In the switching tab 2, tabs (folder tab 2a, calendar tab 2b, and Exif tag tab 2c) are disposed to switch images displayed on the image retrieval screen 1. The browse area 3 displays classification information corresponding to a switched tab. The keyword area 4 comprises a keyword character string 4a and a keyword deletion button 4b. The thumbnail area 5 displays a thumbnail image.

Next, an outline of the image retrieving method will be given by referring to FIGS. 1 to 3.

FIG. 1 shows the image retrieval screen 1 when the folder tab 2a is selected. When the user selects the folder tab 2a, a folder tree is displayed in the browse area 3. A structure of this folder tree is displayed in a known form, and thus detailed description thereof will be omitted. When the user selects a desired folder from this tree, an image file present below the folder is retrieved from an image management DB 34. Then, a thumbnail image that is an index image of the image file is displayed in the thumbnail area 5.

Next, when the user clicks the character string 4a of a specific keyword in the keyword area 4, a thumbnail image of an image to which a keyword has been added is displayed in the thumbnail area 5. Designation and displaying of the specific keyword is referred to as “narrowed-down displaying”. On the other hand, when the user clicks the character string 4a of “all displaying” in the keyword area 4, a thumbnail image of an image to which any one of keywords displayed in the keyword area 4 has been added is displayed in the thumbnail area 5. Designation and displaying of all the keywords are referred to as “all displaying”.

Subsequently, when the user drags and drops the thumbnail image of the thumbnail area 5 on a specific keyword character string 4a of the keyword area 4, the specific character is added as a keyword to the image. It is to be noted that even when the user drags and drops the thumbnail image of the thumbnail area 5 on the “all displaying” character string 4a of the keyword area 4, a keyword is not added. On the other hand, when the user drags and drops the thumbnail image of the thumbnail area 5 on the keyword deletion button 4b of the keyword area 4, a specific keyword or all keywords are deleted from the image.

When the user drags and drops the folder of the browse area 3 on the specific character string 4a or the keyword deletion button 4b of the keyword area 4, keywords are added or deleted to/from all the image files below the folder in the aforementioned manner.

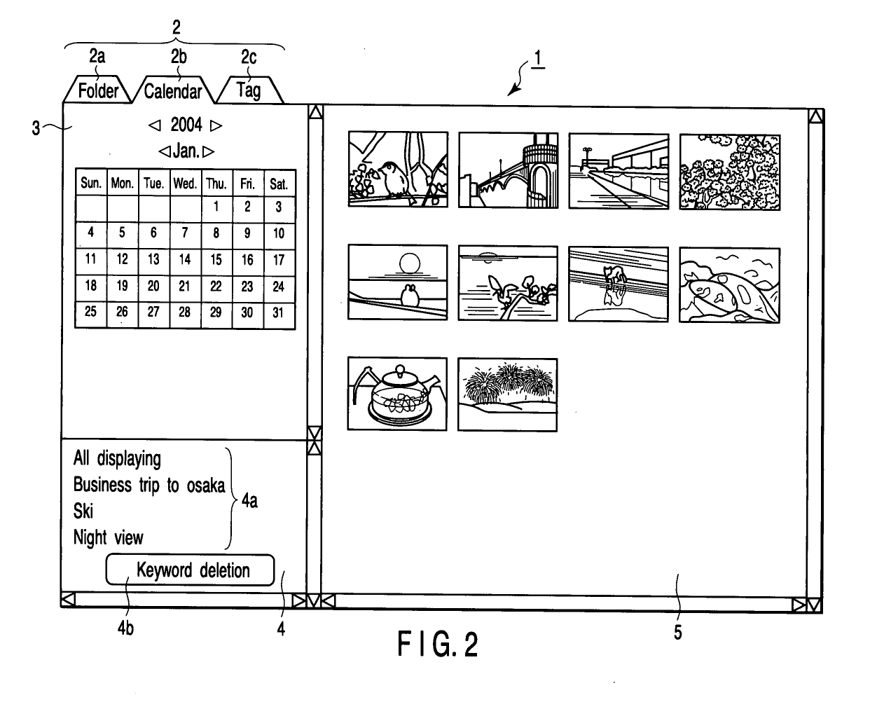

FIG. 2 shows the image retrieval screen 1 when the calendar tab 2b is selected. When the user selects the calendar tab 2b, a calendar is displayed in the browse area 3. Accordingly, when the user selects a calendar year/month and a desired date from the calendar, a thumbnail image of an image file photographed or the like on that date is displayed in the thumbnail area 5.

Next, when the user clicks the character string 4a of a specific keyword in the keyword area 4, a thumbnail image of an image having the keyword is displayed in the thumbnail area 5. On the other hand, when the user clicks the character string 4a of “all displaying” in the keyword area 4, a thumbnail image of an image having any one of keywords displayed in the keyword area 4 is displayed in the thumbnail area 5.

Subsequently, when the user drags and drops the thumbnail image of the thumbnail area 5 on a specific keyword character string 4a of the keyword area 4, the specific character is added as a keyword to the image. Even when the user drags and drops the thumbnail image of the thumbnail area 5 on the “all displaying” character string 4a of the keyword area 4, a keyword is not added. On the other hand, when the user drags and drops the thumbnail image of the thumbnail area 5 on the keyword deletion button 4b of the keyword area 4, a specific keyword or all keywords are deleted from the image.

When the user drags and drops the date of the browse area 3 on the specific character string 4a or the keyword deletion button 4b of the keyword area 4, keywords are added or deleted to/from all the image files having the date in the aforementioned manner.

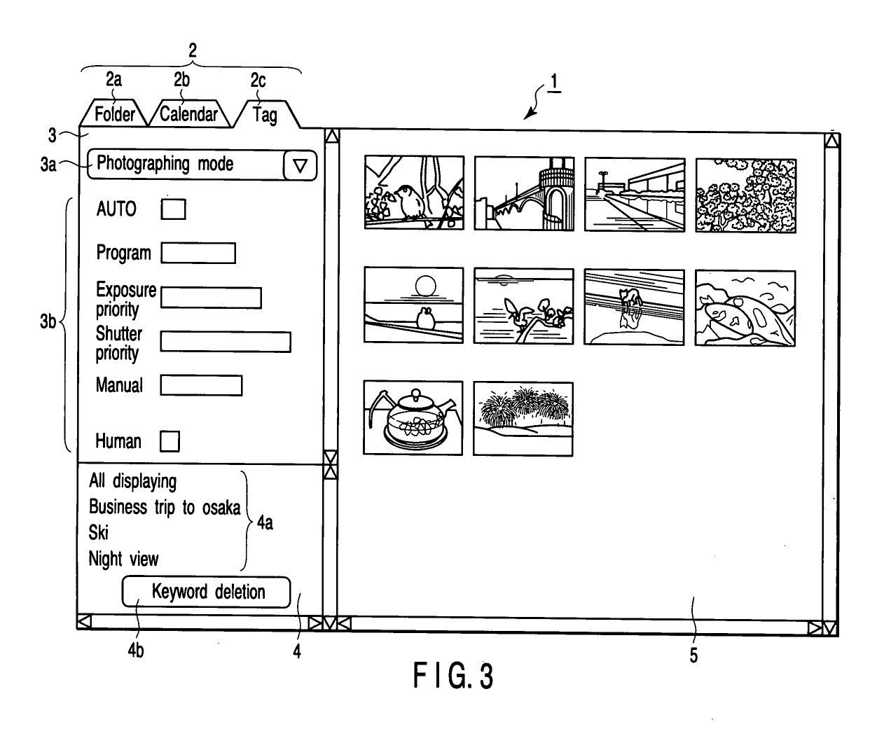

FIG. 3 shows the image retrieval screen 1 when the Exif tag tab 2c is selected. When the user selects the Exif tag tab 2c, an Exif tag selection box 3a is displayed in the browse area 3. When the user selects a desired Exif tag, a thumbnail image of an image file to which the Exif tag has been added is displayed in the thumbnail area 5. Then, the number of image files is displayed as a graph for every contents 3b in the Exif tag.

Next, when the user clicks the character string 4a of a specific keyword in the keyword area 4, a thumbnail image of an image having the keyword is displayed in the thumbnail area 5. On the other hand, when the user clicks the character string 4a of “all displaying” in the keyword area 4, a thumbnail image of an image having any one of keywords displayed in the keyword area 4 is displayed in the thumbnail area 5.

Subsequently, when the user drags and drops the thumbnail image of the thumbnail area 5 on a specific keyword character string 4a of the keyword area 4, the specific character is added as a keyword to the image. When the user drags and drops the thumbnail image of the thumbnail area 5 on the “all displaying” character string 4a of the keyword area 4, all keywords are added to the image. When the user drags and drops the thumbnail image of the thumbnail area 5 on the keyword deletion button 4b of the keyword area 4, a specific keyword or all keywords are deleted from the image.

When the user drags and drops the contents 3b of the browse area 3 on the specific character string 4a or the keyword deletion button 4b of the keyword area 4, keywords are added or deleted to/from all the image files having the tag contents in the aforementioned manner.

Next, a configuration of an image retrieving apparatus for realizing the aforementioned image retrieving method, and its main process will be described.

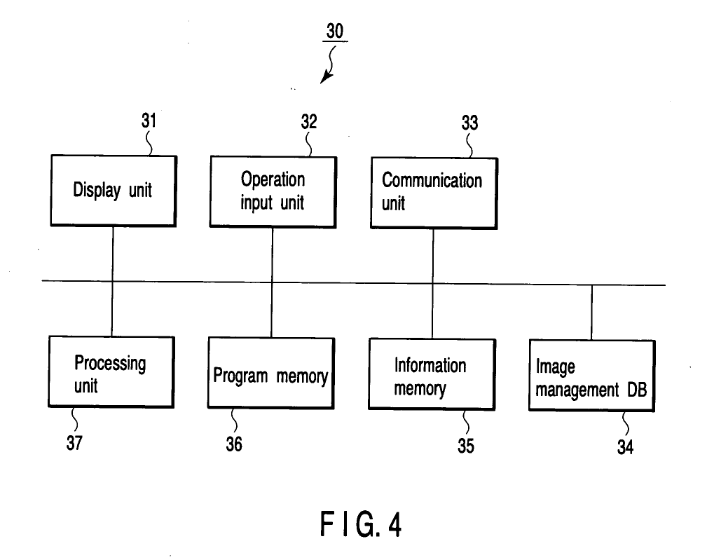

FIG. 4 shows a configuration of an image retrieving apparatus 30. The image retrieving apparatus 30 comprises a display unit 31, an operation input unit 32, a communication unit 33, an image management DB 34, an information memory 35, a program memory 36, and a processing unit 37.

The display unit 31 is a CRT, a liquid crystal display, a plasma display or a projector for displaying the image retrieval screen 1. The operation input unit 32 is an input device such as a keyboard or a mouse for receiving an operation instruction input from the user. The communication unit 33 is an interface for transferring information such as an image file with an external device (not shown) such as a digital camera.

The image management DB 34 saves various pieces of information for managing images, such as a keyword, folder path information, and Exif tag information. The information memory 35 stores an image file. For example, an image file received from the external device such as a digital camera is saved through the communication unit 33 in the information memory 35. The program memory 36 saves a program for controlling each function of the image retrieving apparatus 30. The processing unit 37 is in overall control of an operation of the image retrieving apparatus 30.

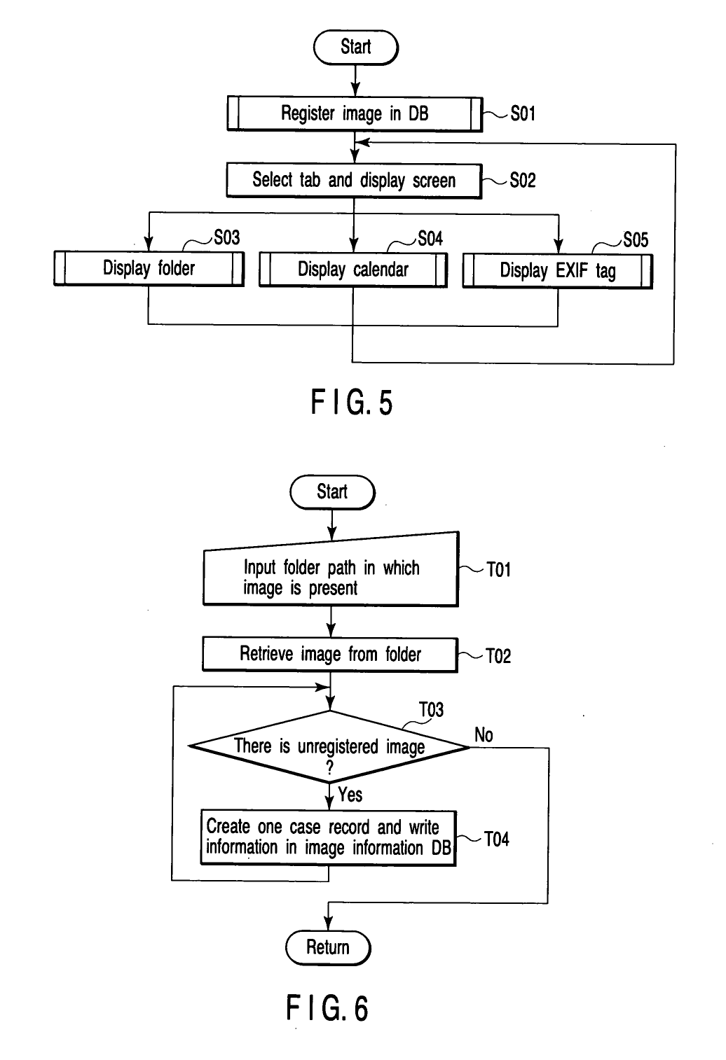

Next, a rough image retrieving process will be described by referring to FIGS. 5 to 18. It is to be noted that the described process concerns main ones of image retrieving functions. Accordingly, even in the case of functions not described below, those described with reference to FIGS. 1 to 4 are within the image retrieving functions.

In a step S01 of FIG. 5, the processing unit 37 executes registration of images in the image management DB 34 (FIG. 6).

In steps T01 to T02 of FIG. 6, when the user designates a folder path having an image to be processed from the operation input unit 32, the processing unit 37 retrieves images from the folder. Then, in steps T03 to T04, for all the retrieved images, determination is made as to whether management information regarding the images has been registered or not in the image management DB 34. In the case of Yes in the step T03, i.e., the management has not been registered, one record of the management information regarding the images is created and stored in the information management DB 34. Then, all the images in the folder are registered, and the process returns.

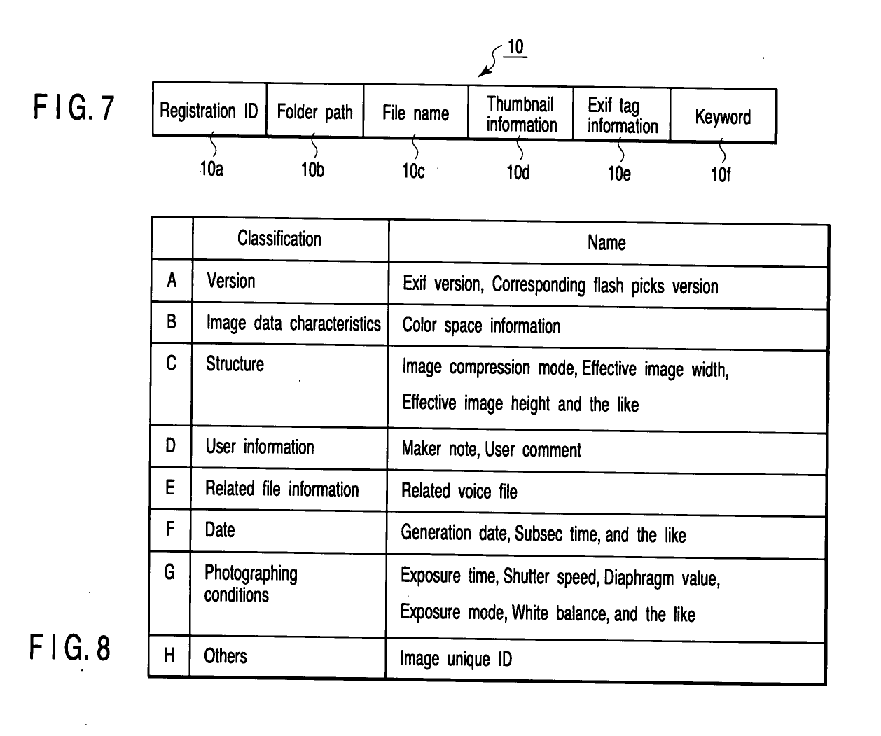

FIG. 7 shows a structure of a registration record registered in the information management DB. A registration record 10 comprises a registration ID area 10a, a folder path area 10b, a file name area 10c, a thumbnail information area 10d, an Exif tag information area 10e, and a keyword area 10f.

In the registration ID area 10a, a unique symbol is added to each record. In the folder path area 10b, path information to a folder having an image saved there is written. In the file name area 10c, a name is written to identify an image file. In the thumbnail information area 10d, thumbnail image data is saved. In the Exif tag information area 10e, contents of an Exif tag are written. In the keyword area 10f, a keyword is saved to be added to the image.

It is to be noted that not only the image data but also photographic information regarding an image are recorded in the image file. Representative photographic information is Exif information recorded in a header of the image file.

FIG. 8 is a table showing an example of a representative structure of accessory information (Exif tag) of an image file of an Exif form which is a kind of photographic information. Such information is recorded in the image file together with the image data as described above.

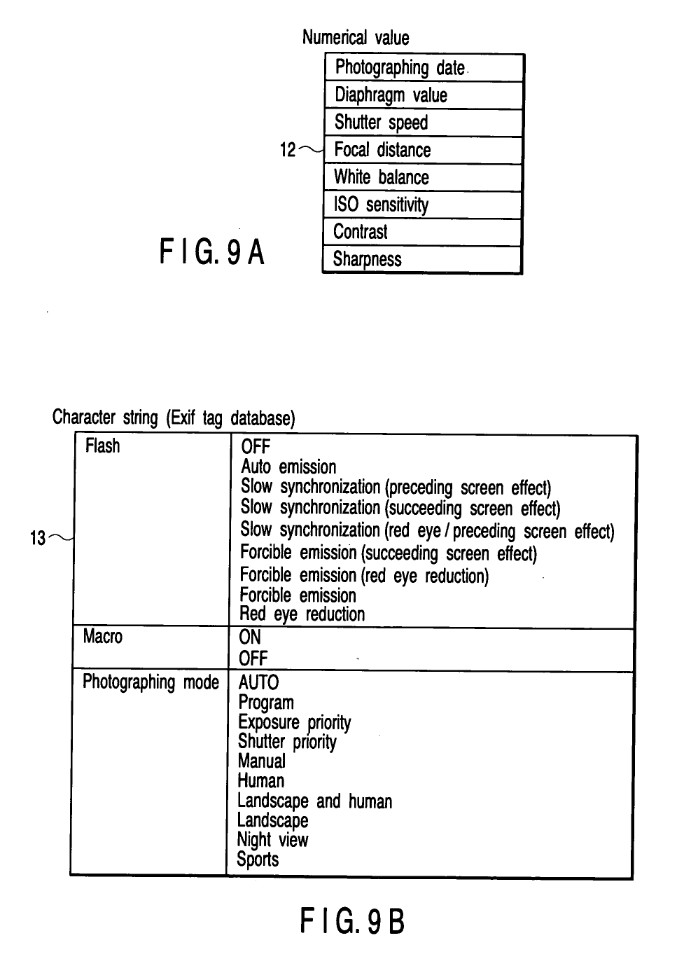

FIG. 9A shows representative contents of a numerical value Exif tag 12, and FIG. 9B representative contents of a character string Exif tag 13.

Representative items of the numerical value Exif tag 12 are “photographing date”, “diaphragm value”, “shutter speed”, “focal distance”, and the like. Contents of each item of the numerical value Exif tag 12 are represented by numerals. Representative items of the character string Exif tag 13 are “flash”, “macro”, “photographic mode”, and the like. Contents of each item of the character string Exif tag 13 are character strings which are predetermined.

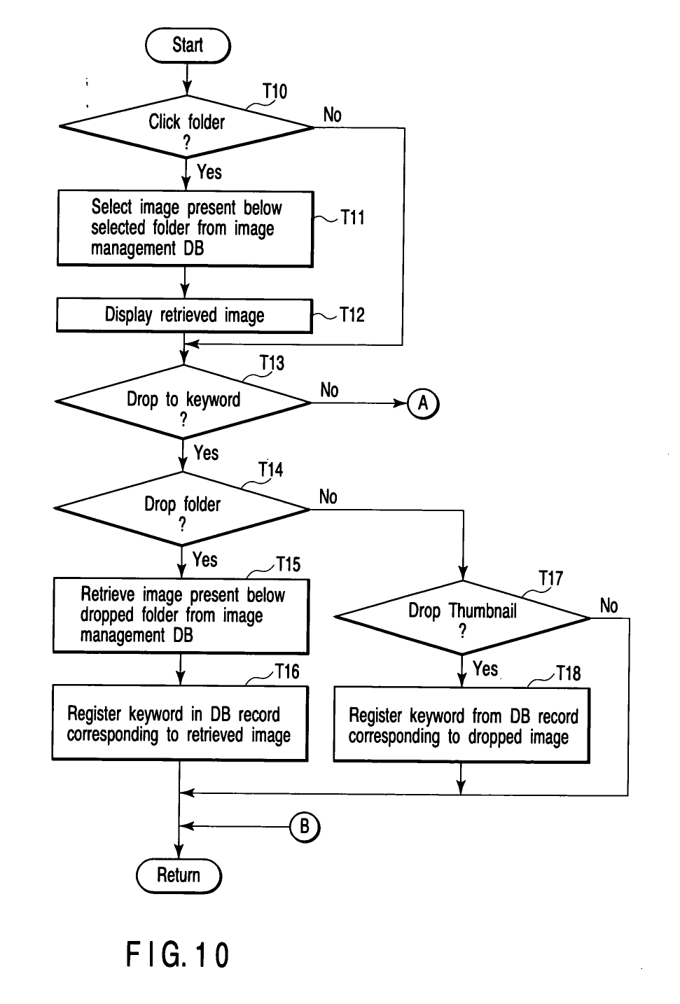

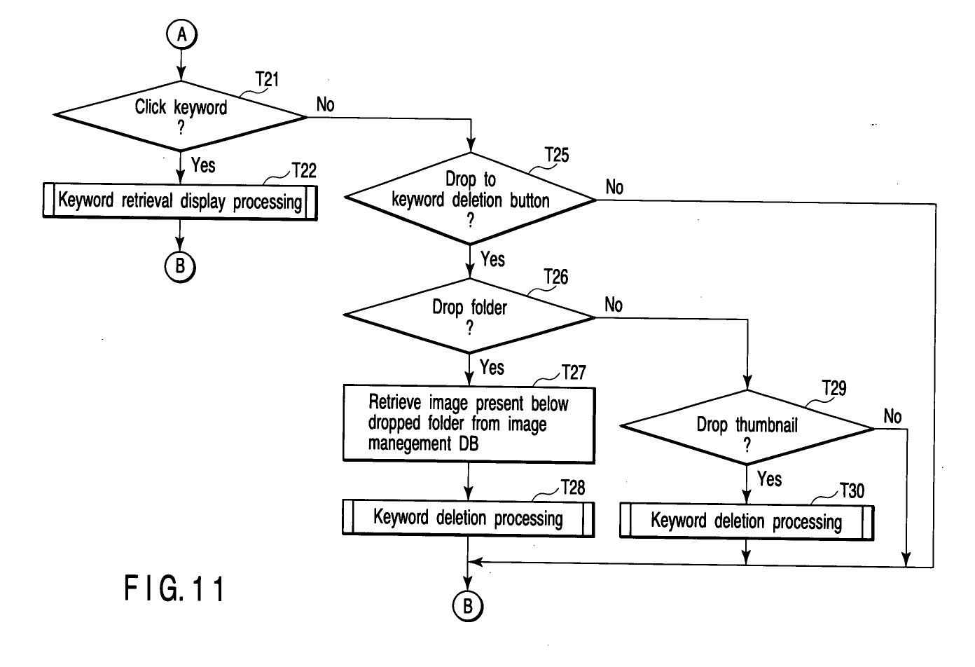

Referring back to FIG. 5, when the user selects any one of the switching tabs 2, in a step S02, the processing unit 37 displays the image retrieval screen 1 corresponding to the selected switching tab 2, and waits for user's next operation. Then, when the user selects the folder tag 2a and executes an operation for image retrieval, folder display processing of a step S03 (FIGS. 10, 11) is executed.

In the case of Yes in a step T10 of FIG. 10, i.e., when the user clicks the folder of the browse area 3, in steps T11 to T12, the processing unit 37 retrieves the registration record 10 from the image management DB 34, and specifies one having a relevant folder name written in the folder path area 10b. Then, thumbnail information stored in the thumbnail information area 10d of the specified registration record 10 is extracted and displayed in the thumbnail area 5.

Next, in the case of Yes in both of steps T13 and T14, i.e., when the folder is dropped on the keyword character string 4a of the keyword area 4, in steps T15 to T16, the registration record 10 is retrieved from the image management DB 34, and one having a name of the dropped folder written in the folder path area 10b is specified. Then, a corresponding keyword is registered in the keyword area 10f of the specified registration record 10, and the process returns.

On the other hand, in the case of Yes in a step T17, i.e., when the thumbnail image is dropped on the keyword character string 4a of the keyword area 4, in a step T18, the registration record 10 is retrieved from the image management DB 34, and one having a name of an image file written in the file name area 10c, the image file corresponding to the dropped thumbnail image, is specified. Then, a corresponding keyword is registered in the keyword area 10f of the specified registration record 10, and the process returns.

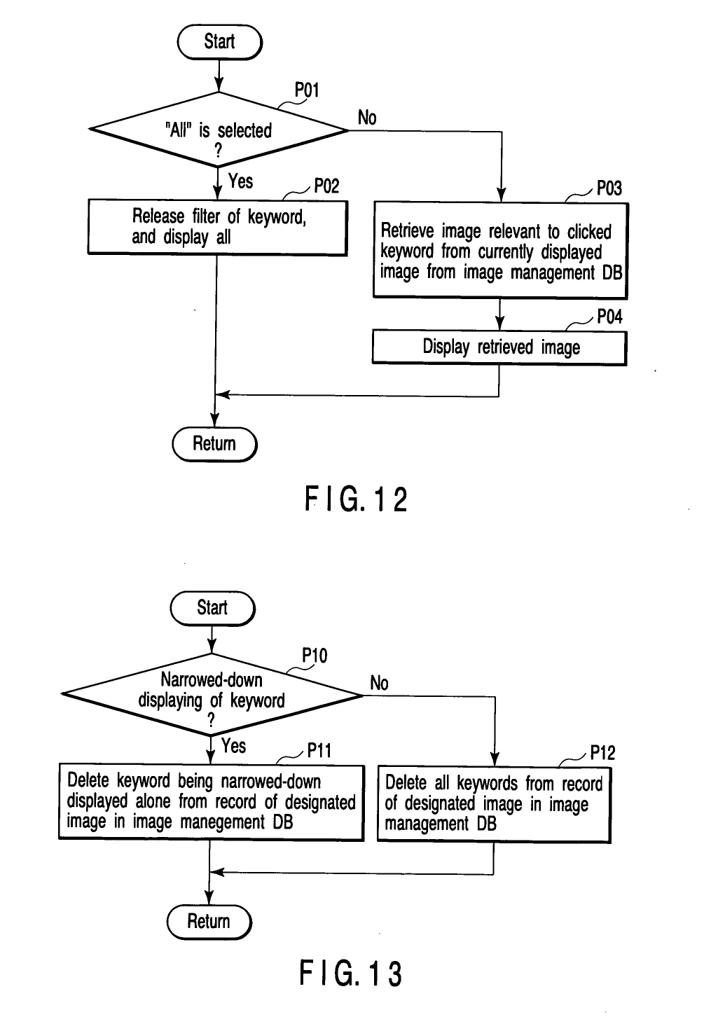

In the case of Yes in a step T21 of FIG. 11, i.e., when the keyword character string 4a of the keyword area 4 is clicked, in a step T22, keyword retrieval displaying is executed (FIG. 12), and the process returns.

In the case of Yes in a step P01 of FIG. 12, i.e., when the “all displaying” character string 4a of the keyword area 4 is clicked, in a step P02, a limit by a keyword is released to display all thumbnail images in the thumbnail area 5. In the case of No in the step P01 of FIG. 12, i.e., when a specific character string 4a of the keyword area 4 is clicked, in steps P03 to P04, among currently displayed images, an image having its specific character string written as a keyword in the keyword area 10f of the corresponding registration record 10 is retrieved, and its thumbnail image is displayed in the thumbnail area 5.

In the case of Yes in both of steps T25 and T26 of FIG. 11, i.e., when the folder is dropped on the keyword deletion button 4b of the keyword area 4, in steps T27 to T28, the registration record 10 is retrieved from the image management DB 34, and one having a name of a relevant folder written in the folder path area 10b is specified. Then, keyword deletion processing of a step T28 (FIG. 13) is executed, and the process returns.

In the case of Yes in a step P10 of FIG. 13, i.e., when the thumbnail image is displayed in the thumbnail area 5 in a manner of “narrowed-down displaying”, in a step P11, for all the image files below the folder, a keyword being displayed in a narrowed-down manner alone is deleted from the keyword area 10f of the registration record 10. On the other hand, in the case of No in the step P10, i.e., when the thumbnail image is displayed in the thumbnail area 5 in a manner of “all displaying”, in a step P12, for all the image files below the folder, all keywords are deleted from the keyword area 10f of the registration record 10.

On the other hand, in the case of Yes in the step T25, No in the step T26, and Yes in the step T29, i.e., when the thumbnail image is dropped on the keyword deletion button 4b of the keyword area 4, keyword deletion processing of a step T30 (FIG. 13) is executed, and the process returns.

In the case of Yes in the step P10 of FIG. 13, i.e., when the thumbnail image displayed in the thumbnail area 5 in the manner of “narrowed-down displaying”, in the step P11, for the thumbnail image, the keyword being displayed in the narrowed-down manner alone is deleted from the keyword area 10f of the registration record 10. On the other hand, in the case of No in the step P10, i.e., when the thumbnail image is displayed in the thumbnail area 5 in the manner of “all displaying”, in the step P12, for the thumbnail image, all the keywords are deleted from the keyword area 10f of the registration record 10.

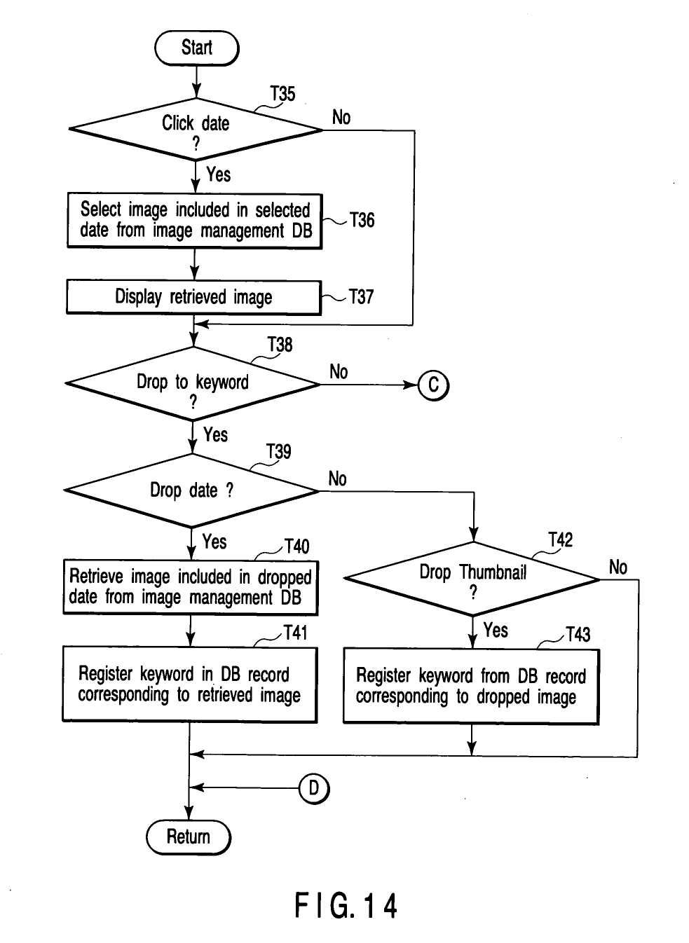

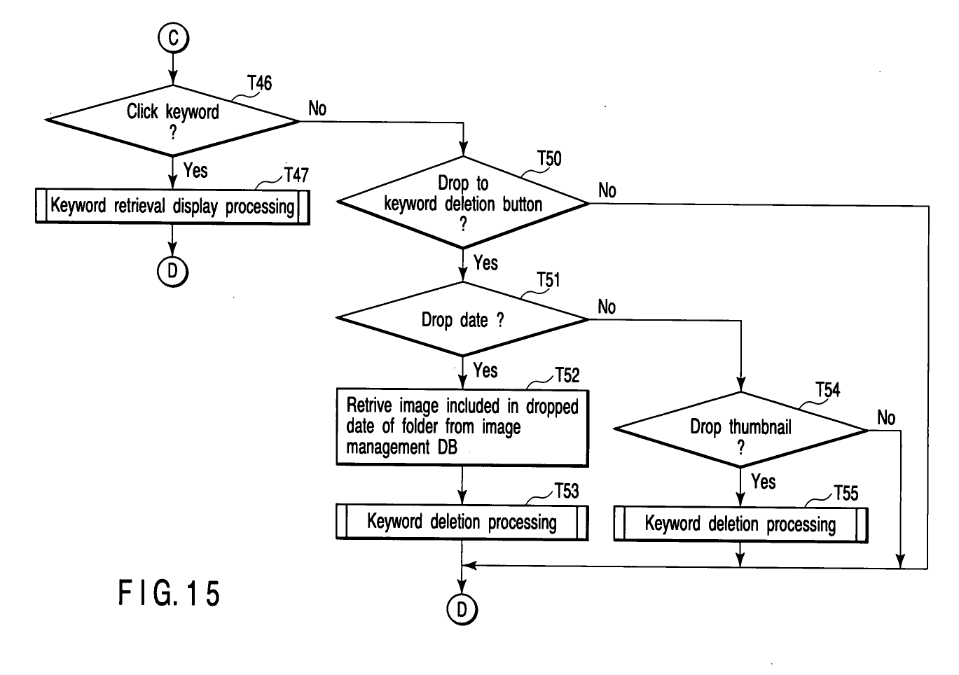

Referring back to FIG. 5, when the user selects the calendar tab 2b and executes an operation of image retrieval, calendar display processing shown in a step S04 is carried out (FIGS. 14, 15).

In the case of Yes in a step T35 of FIG. 14, i.e., when the user clicks the date of the calendar of the browse area 3, in steps T36 to T37, the processing unit 37 retrieves the registration record 10 from the image management DB 34, and specifies one in which “photographing day” in the numerical value Exif tag 12 of the Exif tag information area 10e matches the calendar date. Then, thumbnail information stored in the thumbnail information area 10d of the specified registration record 10 is extracted and displayed in the thumbnail area 5.

Next, in the case of Yes in both of steps T38 and T39, i.e., when the folder is dropped on the keyword character string 4a of the keyword area 4, in steps T40 to T41, the registration record 10 is retrieved from the image management DB 34, and one in which “photographing day” in the numerical value Exif tag 12 of the Exif tag information area 10e matches the calendar date is specified. Then, a corresponding keyword is registered in the keyword area 10f of the specified registration record 10, and the process returns.

On the other hand, in the case of Yes in a step T42, i.e., when the thumbnail image is dropped on the keyword character string 4a of the keyword area 4, in a step T43, the registration record 10 is retrieved from the image management DB 34, and one having a name of an image file written in the file name area 10c, the image file corresponding to the dropped thumbnail image, is specified. Then, a corresponding keyword is registered in the keyword area 10f of the specified registration record 10, and the process returns.

In the case of Yes in a step T46 of FIG. 15, i.e., when the keyword character string 4a of the keyword area 4 is clicked, in a step T47, keyword retrieval displaying is executed (FIG. 12), and the process returns. This keyword retrieval displaying is similar to the foregoing, and thus detailed description thereof will be omitted.

In the case of Yes in both of steps T50 and T51 of FIG. 15, i.e., when the date is dropped on the keyword deletion button 4b of the keyword area 4, in steps T52 to T53, the registration record 10 is retrieved from the image management DB 34, and one in which “photographing day” in the numerical value Exif tag 12 of the Exif tag information area 10e matches the calendar rate is specified. Then, keyword deletion processing of a step T53 (FIG. 13) is executed, and the process returns. This keyword deletion processing is similar to the foregoing, and thus detailed description thereof will be omitted.

On the other hand, in the case of Yes in the step T50, No in the step T51, and Yes in the step T54, i.e., when the thumbnail image is dropped on the keyword deletion button 4b of the keyword area 4, keyword deletion processing of a step T55 (FIG. 13) is executed, and the process returns. This keyword deletion processing is similar to the foregoing, and thus detailed description thereof will be omitted.

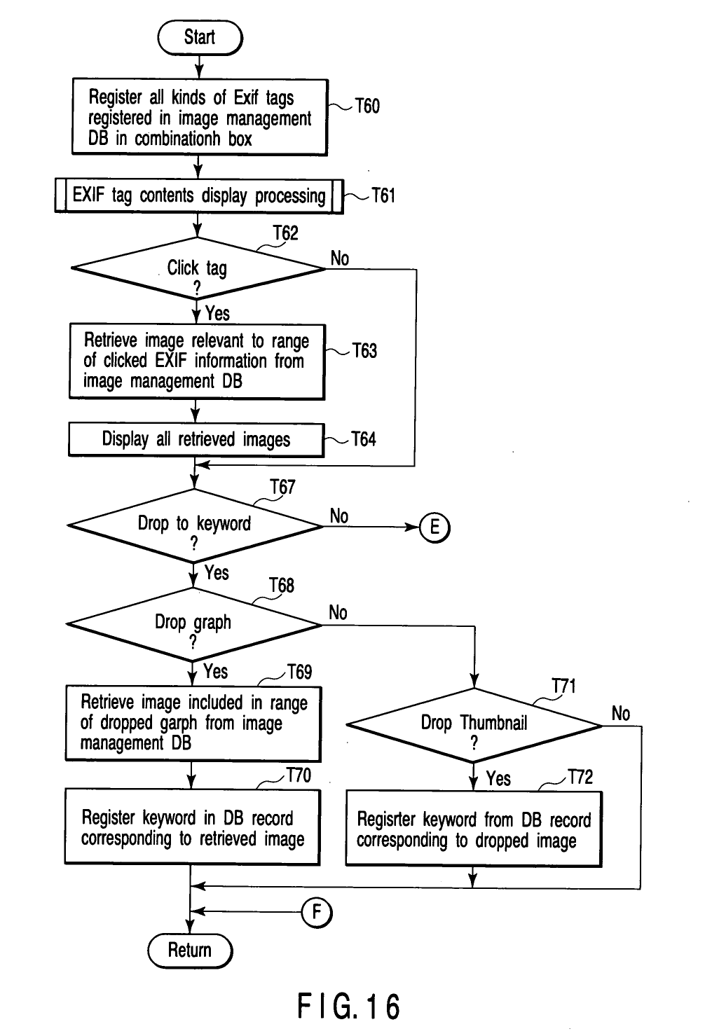

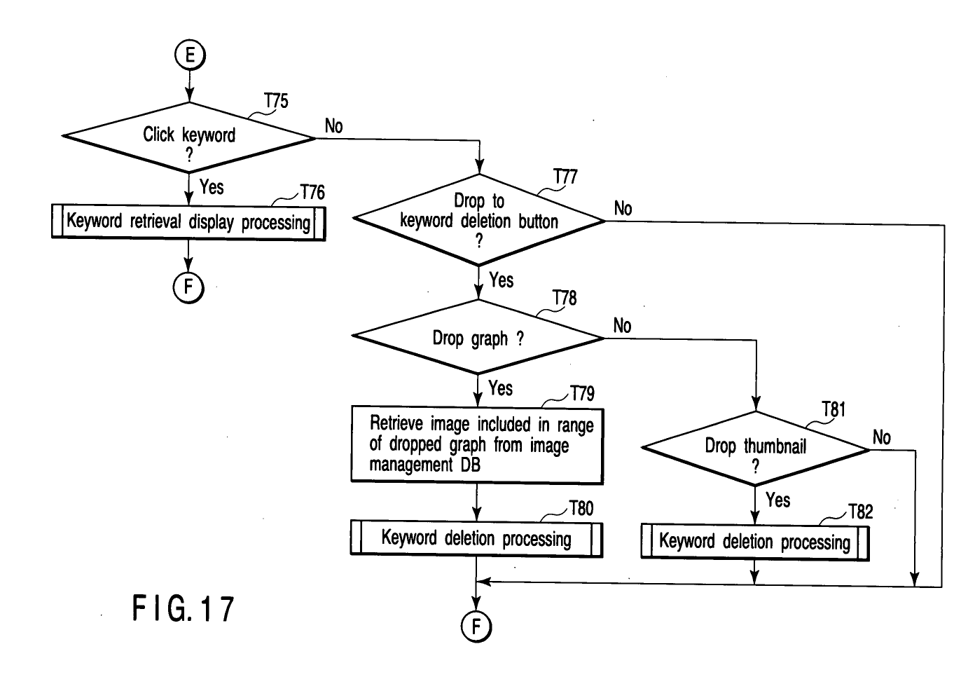

Referring back to FIG. 5, when the user selects the Exif tag tab 2c and executes an operation of image retrieval, Exif tag display processing shown in a step S05 is carried out (FIGS. 16, 17).

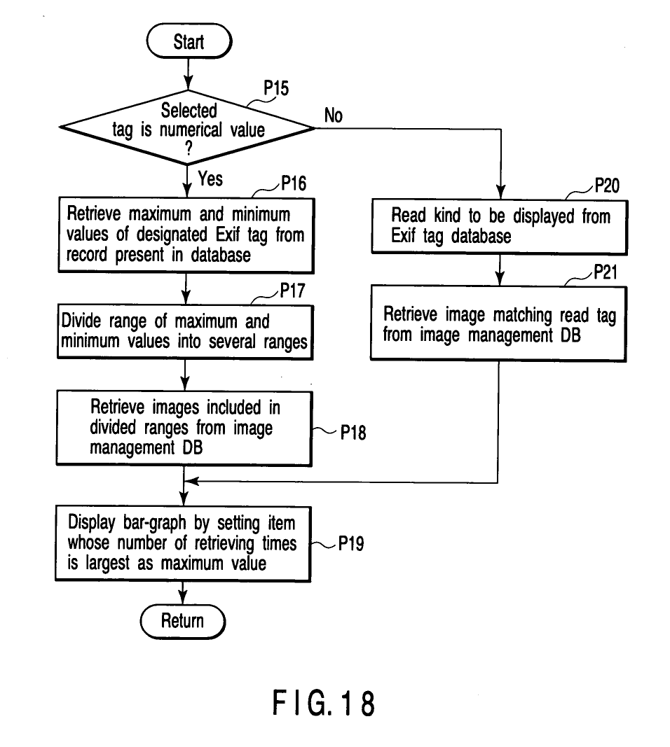

In a step T60 of FIG. 16, the processing unit 37 registers all kinds of Exif tags (FIG. 9) registered in the image management DB 34 in the Exif tag selection box 3a. In a step S61, Exif tag contents display processing (FIG. 18) is executed.

In the case of Yes in a step P15 of FIG. 18, i.e., when an Exif tag selected by the user is a numerical value type, in steps P16 to P19, the Exif tag information area 10e is checked to retrieve maximum and minimum values of the designated Exif tag. Then, a range of the maximum and minimum values is divided into a predesignated number of areas. Next, the numbers of images included in the divided ranges are retrieved, and the range in which the number of retrieved images is largest is displayed in a graph, and the process returns.

In the case of No in the step P15 of FIG. 18, i.e., when an Exif tag selected by the user is a character string type, in steps P20 to P21, a kind of the Exif tag to be displayed from the Exif tag information area 10e and a name of the Exif tag are checked from the Exif tag database 13 to read contents 3b of the Exif tag displayed in the browse area 3. Next, the number of images included in the read contents 3b of the Exif tag is retrieved. Then, in a step P19, an item whose retrieving number of times is largest in the contents 3b of the Exif tag is displayed as a maximum value in a graph, and the process returns.

In the case of Yes in a step T62 of FIG. 16, i.e., when the user clicks the graph of the browse area 3, in steps T63 to T64, the processing unit 37 searches in the Exif tag information area of the registration record 10 to specify one which an Exif tag value is within a range of the graph. Then, a thumbnail image is extracted from the specified registration record 10, and displayed in the thumbnail area 5.

Next, in the case of Yes in both of steps T67 and T68, i.e., when the graph is dropped on the keyword character string 4a of the keyword area 4, in steps T69 to T70, search is carried out in the Exif tag information area 10e of the registration record 20 to specify one in which an Exif tag value is within the range of the graph. Then, a corresponding keyword is registered in the specified registration record 10, and the process returns.

On the other hand, in the case of Yes in a step T71, i.e., when the thumbnail image is dropped on the keyword character string 4a of the keyword area 4, in a step T72, the registration record 10 is retrieved from the image management DB 34, and one having a name of a relevant image file written in the file name area 10c is specified. Then, a corresponding keyword is registered in the keyword area 10f of the specified registration record 10, and the process returns.

In the case of Yes in a step T75 of FIG. 17, i.e., when the keyword character string 4a of the keyword area 4 is clicked, in a step T76, keyword retrieval displaying is executed (FIG. 12), and the process returns. This keyword retrieval displaying is similar to the foregoing, and thus detailed description thereof will be omitted.

Next, in the case of Yes in both of steps T77 and T78 of FIG. 17, i.e., when the graph is dropped on the keyword deletion button 4b of the keyword area 4, in steps T79 to T80, search is carried out in the Exif tag information area 10e of the registration record 10 to specify one in which an Exif tag value is within the range of the graph. Then, keyword deletion processing of a step T80 (FIG. 13) is executed, and the process returns. This keyword deletion processing is similar to the foregoing, and thus detailed description thereof will be omitted.

On the other hand, in the case of Yes in the step T77, No in the step T78, and Yes in the step T81, i.e., when the thumbnail image is dropped on the keyword deletion button 4b of the keyword area 4, keyword deletion processing of a step T82 (FIG. 13) is executed, and the process returns. This keyword deletion processing is similar to the foregoing, and thus detailed description thereof will be omitted.

According to the embodiment of the invention, the keyword and the image are correlated by dragging and dropping. However, the invention is not limited to this system. An operation may be performed which selects a keyword and an image and correlates them.

### Second Embodiment

Next, an image retrieving method according to a second embodiment of the present invention will be described. The second embodiment is different from the first only in a structure of an image retrieval screen. Portions similar to those of the first embodiment are denoted by similar reference numerals, and detailed description thereof will be omitted.

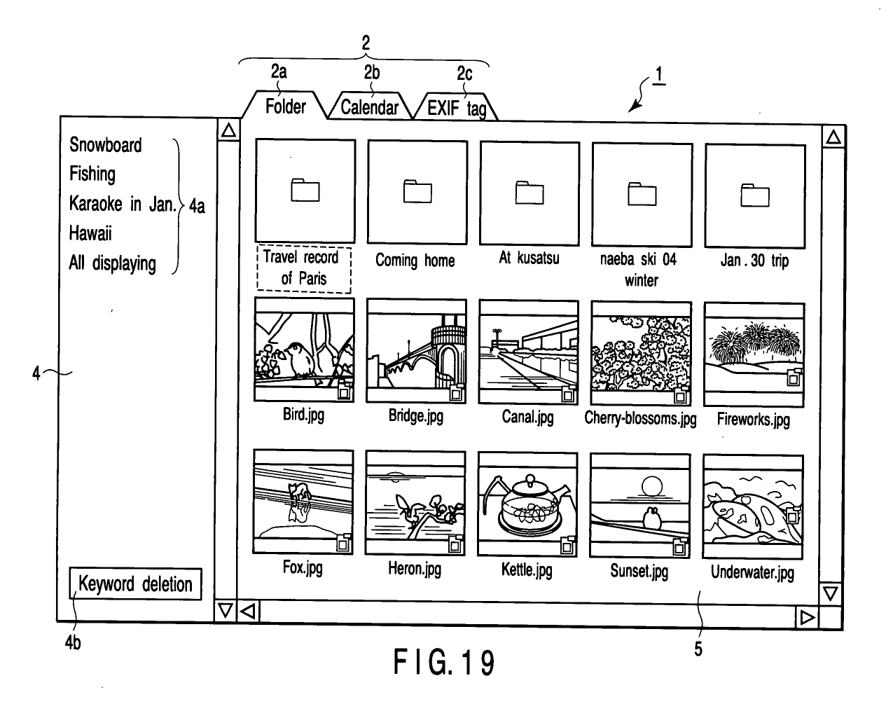

FIG. 19 shows an image retrieval screen 1 when a folder tab 2a is selected. Different from the first embodiment, a folder is displayed together with a thumbnail image in a thumbnail area 5.

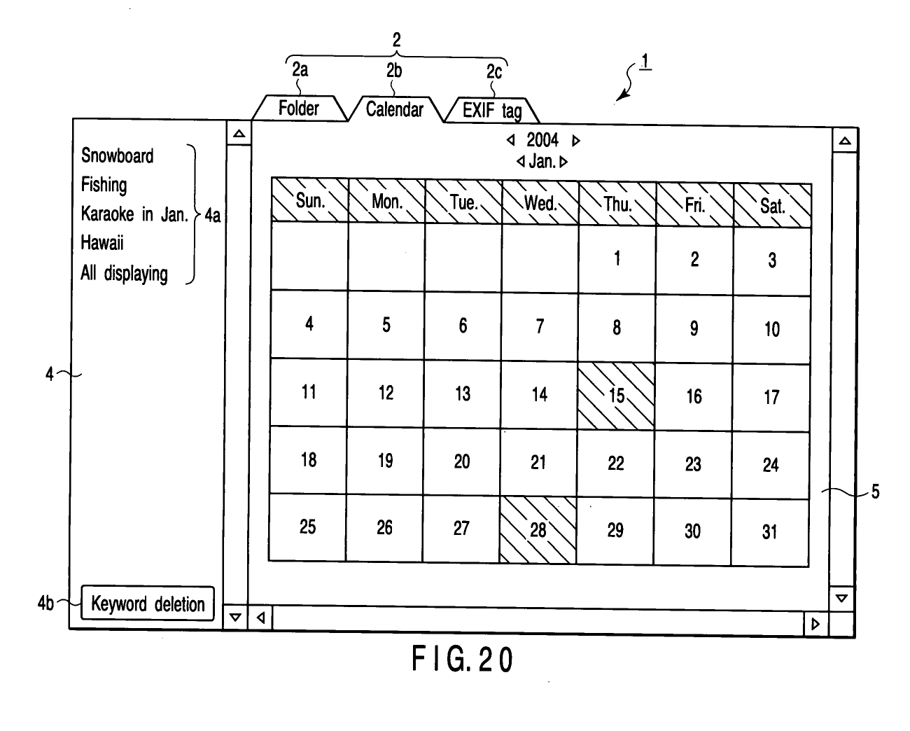

FIG. 20 shows the image retrieval screen 1 when a calendar tab 2b is selected. Different from the first embodiment, a calendar is displayed in the thumbnail area 5.

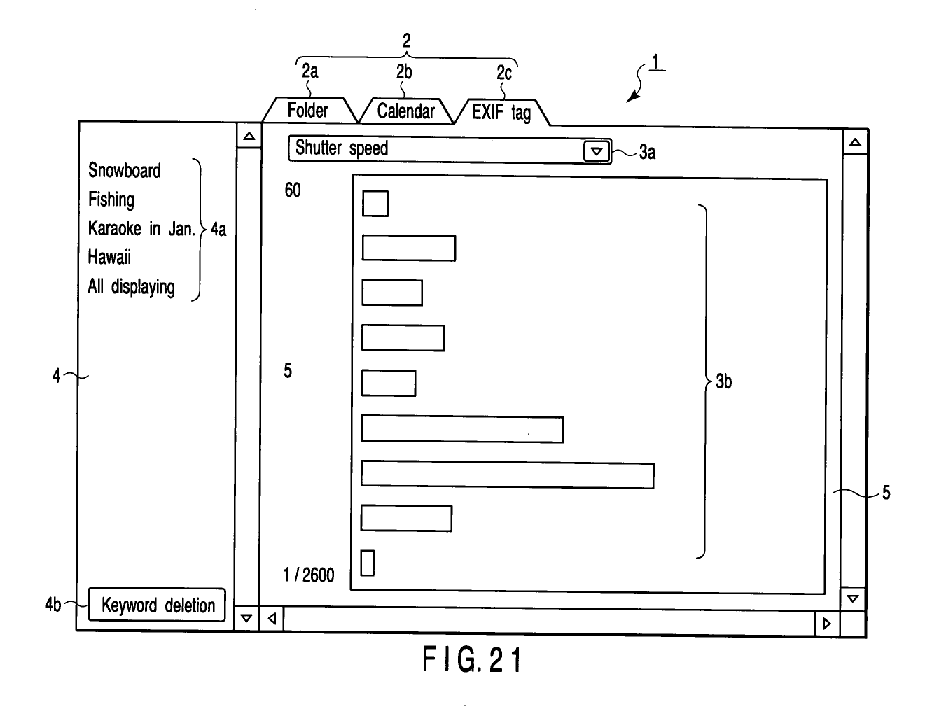

FIG. 21 shows the image retrieval screen 1 when an Exif tag tab 2c is selected. Different from the first embodiment, an Exif tag selection button 3a and a graph are displayed in the thumbnail area 5.

According to the first and second embodiments described above, the operations regarding the keyword registration are unified. That is, the followings can be carried out by the same operation: (1) addition of a keyword to an index image relevant to specific photographic information of designated year, month and day, (2) addition or deletion of a keyword to/from an index image relevant to specified year, month and day correlated with a selected keyword, and (3) addition or deletion of a keyword to/from an index image relevant to specific photographic information correlated with a selected keyword. Thus, it is possible to simplify an operation regarding complicated keyword registration.

### Third Embodiment

Next, an image retrieving method according to a third embodiment of the present invention will be described. According to the image retrieving method of the third embodiment, a keyword is correlated with an image based on an Exif tag which is one piece of photographic information given when the image is photographed.

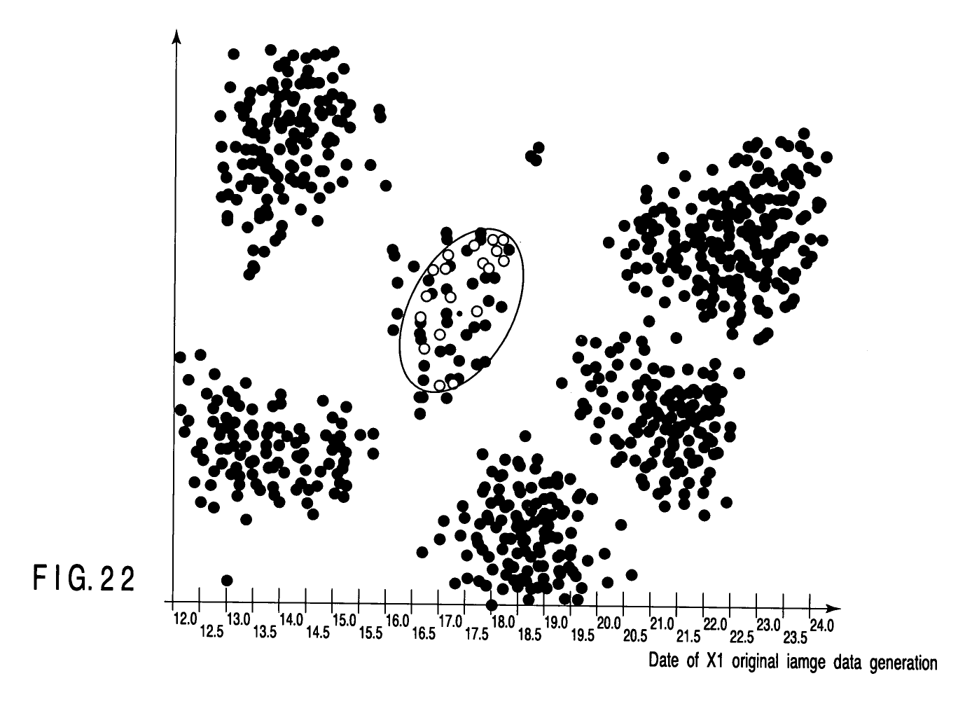

FIG. 22 illustrates a principle of image classification and retrieval. To simplify explanation, a two-dimensional coordinate is taken as an example.

X and Y axes of FIG. 22 represent pieces of photographic information, e.g., a shutter speed and a photographing date. Dots (shown) indicate photographed images. It can be imagined from the drawing that the photographed images can be classified into groups based on the pieces of photographic information. Thus, a desired image can be retrieved by determining a group to which an image to be retrieved belongs and extracting an image belonging to the relevant group.

In an electronic camera, an Exif form is used as an image recording file form as described above. In the image file of the Exif form, photographic image is given as Exif tag information during photographing. FIG. 8 shows an example of an Exif tag. In other words, it is supposed that such information is implicitly added as a keyword to the image without any awareness of the user.

According to the present invention, based on the aforementioned consideration, image retrieval processing is carried out by treating image information as an implicit keyword and executing mathematical processing.

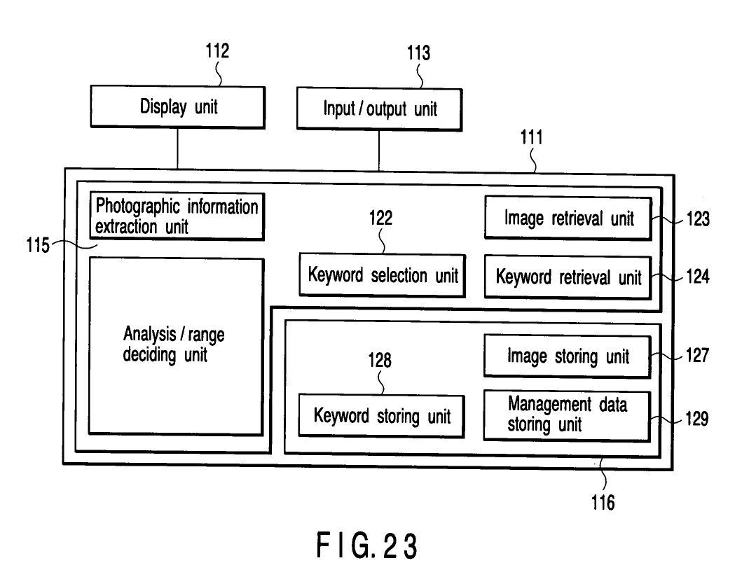

FIG. 23 shows a configuration of an image retrieving apparatus 110 to which the image retracing method of the embodiment of the invention is applied.

The image retrieving apparatus 110 comprises a central processing unit 111, a display unit 112, and an input/output unit 113. The central processing unit 111 executes image classification/management/retrieval. The display unit 112 is a CRT or a TFT liquid crystal display for displaying a screen or the like regarding image retrieval. The input/output unit 113 comprises an input device such as a keyboard or a mouse for receiving an operation instruction input from a user, and a communication interface for transferring information such as image data with an external device.

The central processing unit 111 comprises a processing unit 115 for executing image retrieval or the like, and a storing unit 116 for storing information regarding the image retrieval.

The processing unit 115 comprises a photographic information extraction unit 120, a distribution/range deciding unit 121, an image retrieval unit 122, a keyword selection unit 123, and a keyword retrieval unit 124. The photographic information extraction unit 120 extracts image information from a specified image file. The distribution/range deciding unit 121 generates image distribution information by using photographic information as a parameter, and decides a range belonging to a specific group from the distribution information. The keyword selection unit 123 selects a specific keyword from a list of keywords. The keyword retrieval unit 124 specifies an image file having the specific keyword. The image retrieval unit 123 retrieves a specific image file.

The storing unit 116 comprises an image storing unit 127, a keyword storing unit 128, and a management data storing unit 129. The image storing unit 127 stores an image file. The keyword storing unit 128 stores a keyword and a distribution range by correlating them. The management data storing unit 129 stores a keyword and photographic information by correlating them.

Next, a process of image retrieval according to the embodiment of the invention will be described.

The user executes a registration process in the keyword storing unit 128 as a preparation for image retrieval. In this process, a keyword representing a situation properly set by the user (referred to as “situation keyword”, hereinafter) and information regarding a relevant image file are stored in the keyword storing unit 128.

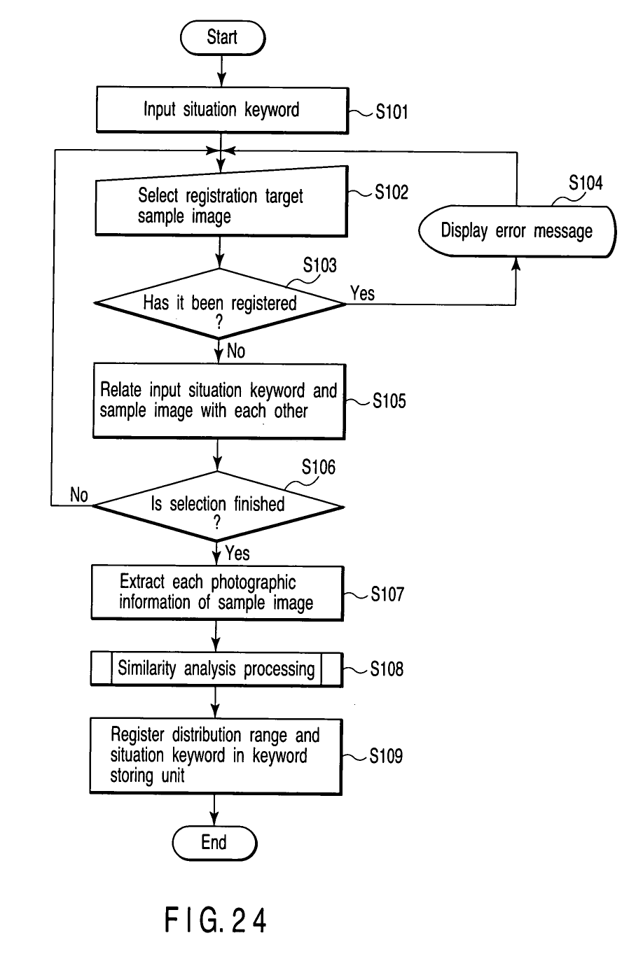

FIG. 24 is a flowchart showing a rough registration process in the keyword string unit 128.

In a step S101, the user inputs a situation keyword by operating the input/output unit 113. The situation keyword is a word representing a situation, for example, when an image is photographed, and it may be “indoor”, “evening glow”, “night view” or the like.

In a step S102, the user selects an image suitable for addition of the situation keyword among image files saved in the image storing unit 127. Hereinafter, the selected image will be referred to as a sample image. In the case of Yes in a step S103, i.e., when sample images are dually selected, in a step S104, an error message is output to the display unit 112, and the process waits for user's next selection of an image.

In the case of No in the steps S103, i.e., when sample images are not dually selected, in a step S105, the input situation keyword and the sample image are correlated. Then, in the case of No in a step S106, i.e., when another sample image is selected, the process from the step S102 is repeated. It is to be noted that the proper number of sample images may be selected by user's intention.

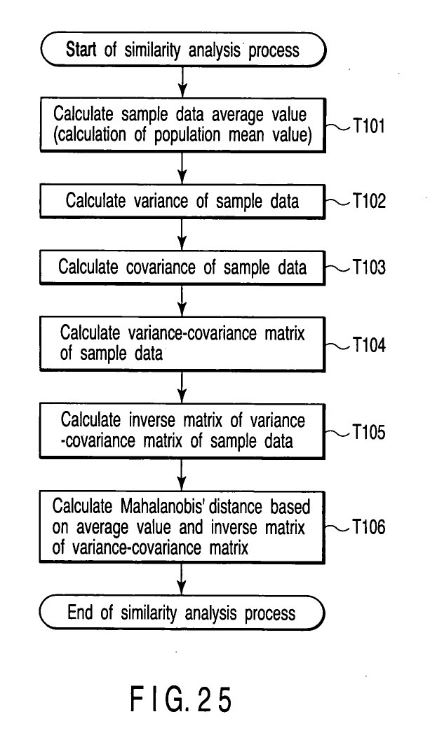

In the case of Yes in the step S106, i.e., when the selection is finished, the photographic information extraction unit 120 extracts Exif information from the image file of the sample image. Then, the distribution/range deciding unit 21 executes similarity analysis processing (FIG. 25) shown in a step S108.

The similarity analysis processing calculates Mahalanobis' distance based on the Exif information of the sample image, and decides a range of similarities to the sample image. Specifically, when white dots in the center of FIG. 22 represent sample images, a range containing data of the white dots (“sample data”, hereinafter), i.e., an elliptical range in FIG. 22, is decided by an arithmetic operation. Hereinafter, Mahalanobis' distance will be described.

In view of a general case, there are assumed to be p variables considered as causes. In this case, Mahalanobis' generalized distance D² is represented by the following equation (1):
D²=(x−μ)′Σ⁻¹(x−μ) (1)

In the equation (1), (x−μ) indicates a difference between data x₁, x₂, . . . of variables 1, 2, . . . and population mean values μ₁, μ₂, . . . of the variables in a matrix, and represented by the following equation (2) when expressed in factors:

$$( x - μ ) = ( \begin{matrix}{x}_{1} - {μ}_{1} \\ {x}_{2} - {μ}_{2} \\ … \\ {x}_{P} - {μ}_{P}\end{matrix} ) \qquad ( 2 )$$

In the equation (1), (x−μ)′ is represented by a matrix obtained by replacing a row and a column of (x−μ) with each other, i.e., a transposed matrix, and represented by the following equation (3):
(x−μ)=(x₁−μ₁ x₂−μ₂ . . . x_{P}−μ_{P}) (3)
In the equation (1), Σ is a variance-covariance matrix, and represented by the following equation (4)

$$\sum = ( \begin{matrix}{σ}_{1}^{2} & {σ}_{12} & … & {σ}_{1 p} \\ {σ}_{21} & {σ}_{2}^{2} & … & {σ}_{2 p} \\ … & … & … & … \\ {σ}_{p1} & {σ}_{p2} & … & {σ}_{p}^{2}\end{matrix} ) \qquad ( 4 )$$

Here, σᵢ² (I=1, 2, . . . p) which is a diagonal factor of the variance-covariance matrix is a variance of a variable i, and σᵢⱼ(I, j)=1, 2, . . . , i and j being different) indicates a covariance between the variables i and j. Σ⁻¹ is an inverse matrix of Σ.

A similarity analysis process shown in FIG. 25 is for realizing the aforementioned arithmetic operation.

In a step T101 of FIG. 25, an average value of sample data, i.e., a population mean value (μ), is calculated. In a step T102, a variance (σᵢ²) of the sample data is calculated. In a step T103, a covariance (σᵢⱼ) of the sample data is calculated. In a step T104, a variance-covariance matrix (Σ) of the sample data is calculated. In a step T105, an inverse matrix (Σ⁻¹) of the variance-covariance matrix of the sample data is calculated. Then, in a step T106, Mahalanobis' distance (D²) is calculated based on the average value and the inverse matrix of the variance-covariance matrix, and the process returns.

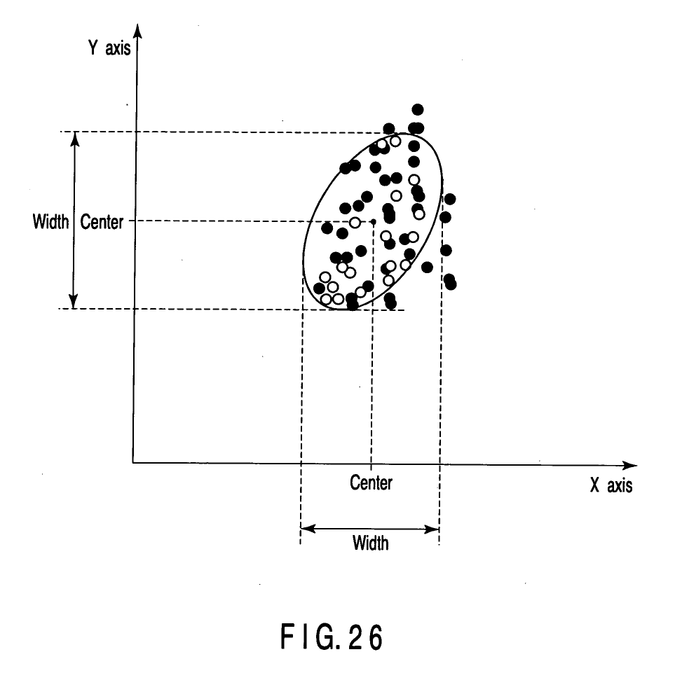

Referring back to FIG. 24, in a step S109, a distribution range is obtained. Here, a distribution range of one variable is a range of an X axis which is one axis corresponding to an elliptical range shown in FIG. 26. Then, this distribution range is represented by making “center point” and “width” a set. For the “center point”, a population mean value μ of the variable is used. For the “width”, a width calculated for the variable based on the Mahalanobis' distance (D²) is used.

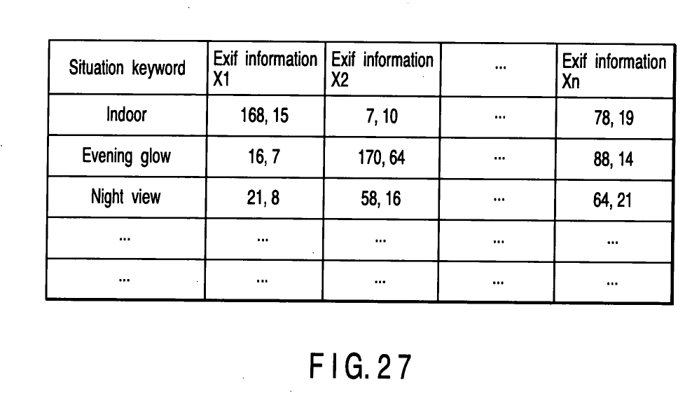

Then, the obtained distribution range and the situation keyword are registered in the keyword storing unit 128. FIG. 27 shows a structure of the keyword storing unit 128. In the keyword storing unit 128, a distribution range of each photographic information (each Exif information) is recorded for each situation keyword input by the user. According to data of the keyword storing unit 128, for example, it can be understood that Exif information X2 of an image having a situation keyword “evening glow” is distributed in a range of a center point 170 and a width 64. This distribution range indicates a similarity range of the situation keyword.

After the user finishes the registration of the situation keyword in the keyword storing unit 128, a registration process in the management data storing unit 129 is executed based on this registration information. This process allocates situation keywords to all the images stored in the image storing unit 127.

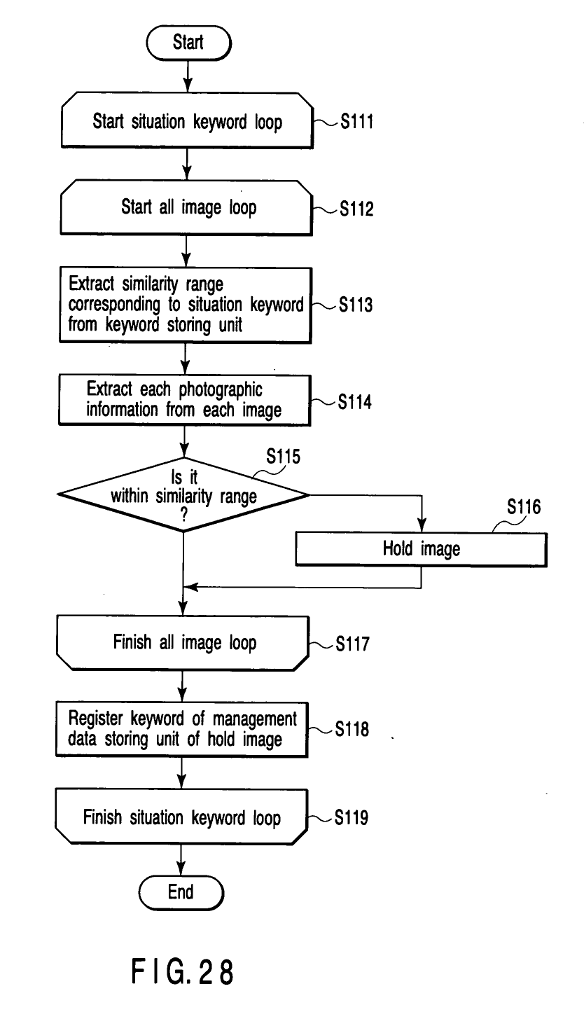

FIG. 28 is a flowchart showing a rough registration process in the management data storing unit 129.

In a step S111, a loop of situation keywords is started. That is, the following processing is repeated for each of all the situation keywords. In a step S112, a loop of all images is started. That is, the following processing is repeated for each of all the images.

In a step S113, search is executed in the keyword storing unit 128 to take out a similarity range of photographic information of one selected situation keyword. Next, in a step S114, photographic image saved in an image file of an image to be processed is taken out.

In a step S115, checking is made as to whether the image to be processed is within the similarity range of the situation keyword or not. In other words, checking is made as to whether each photographic information of the image to be processed belongs to the distribution range (similarity range) of the photographic information stored in the keyword storing unit 128 or not. In the case of Yes in a step S115, i.e., when each photographic information of the image to be processed belongs to the similarity range of all pieces of target photographic information, the image and the situation keyword are correlated to be temporarily stored.

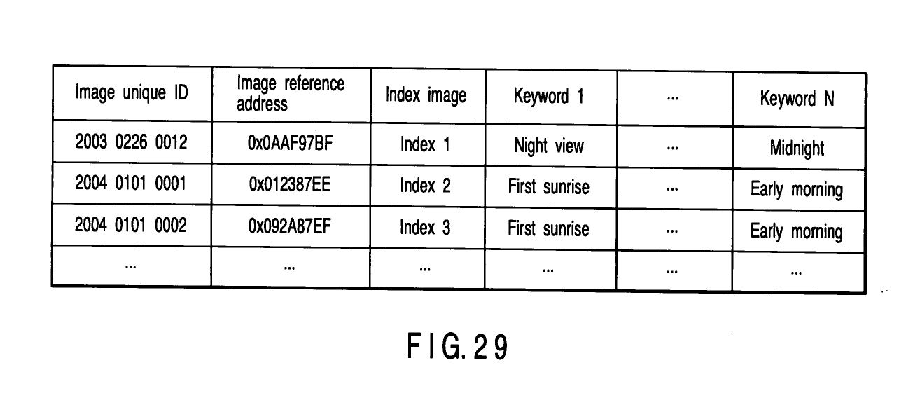

In a step S117, if the similarity determination processing is repeated for all the images, the loop of all the images is finished. Then, in a step S118, the image and the situation keyword that have temporarily been stored are stored in the management data storing unit 129. FIG. 29 shows a structure of the management data storing unit 129. In the management data storing unit 129, “image unique ID” which is information for specifying the image, “image reference address” indicating a position in the image storing unit 127 in which the image has been stored, “index image” which is a thumbnail image of the image, and at least one situation keyword are stored.

Then, when the aforementioned processing is executed for all the situation keywords stored in the keyword storing unit 128, in a step S119, the loop of the situation keywords is finished.

The registration process in the management data storing unit 129 can be executed for a newly input image. For example, through the input/output unit 113, an image read from the camera or the like can be additionally registered in the management data storing unit 129.

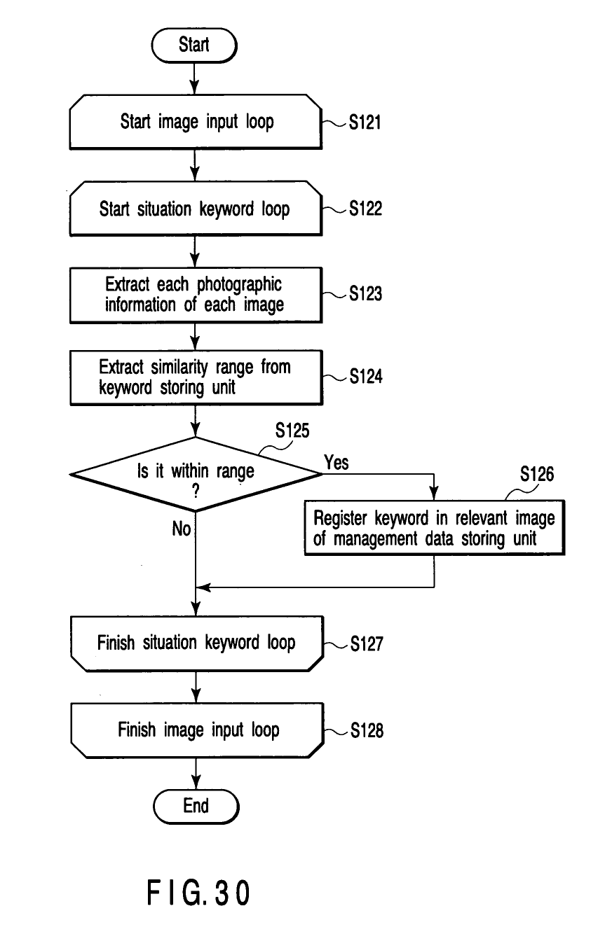

FIG. 30 is a flowchart showing a rough additional registration process in the management data storing unit 129.

In a step S121, an image input loop is started. That is, the following processing is executed for each image read through the input/output unit 113. In a step S122, a loop of situation keywords is started. That is, the following processing is repeated for each of all the situation keywords.

In a step S123, photographic information saved in an image file of an input image to be processed is taken out. Next, in a step S124, search is executed in the keyword storing unit 128 to take out a similarity range of photographic information corresponding to one selected situation keyword.

In a step S125, checking is made as to whether the image to be processed is within the similarity range of the situation keyword or not. In other words, checking is made as to whether each photographic information of the image to be processed belongs to the distribution range (similarity range) of the photographic information stored in the keyword storing unit 128 or not. In the case of Yes in a step S125, i.e., when each photographic information of the image to be processed belongs to the similarity range of all pieces of target photographic information, in a step S126, the situation keyword is stored for the input image in the management data storing unit 129.

Then, when the aforementioned processing is executed for all the situation keywords stored in the keyword storing unit 128, in a step S127, the loop of the situation keywords is finished. In a step S128, when the similarity determination processing is executed for all the read images, the image input loop is finished.

After the end of the registration operations in the keyword storing unit 128 and the management data storing unit 129, an image can be retrieved. According to the image retrieving method of the embodiment, a method of retrieving an image by designating a keyword, and a method of designating an image and retrieving an image similar to the image can be used.

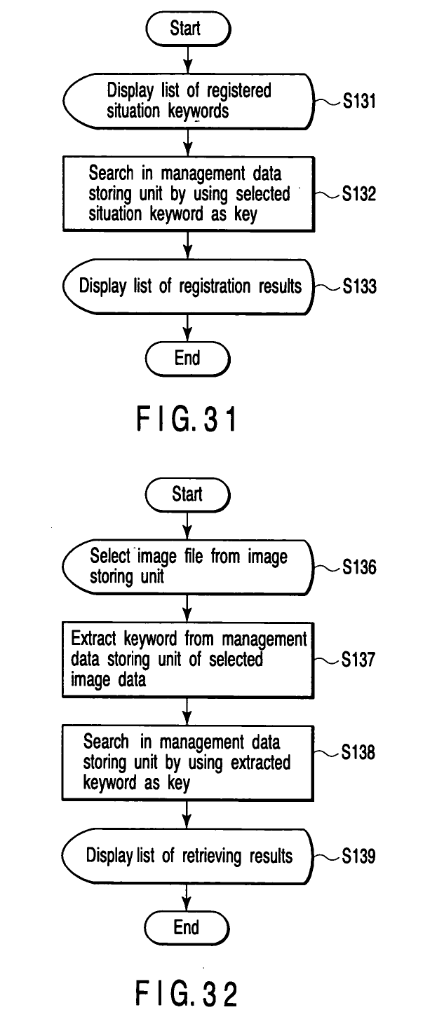

FIG. 31 is a flowchart showing a rough image retrieving process by keywords.

When the user executes an image retrieving operation by keywords through the input/output unit 113, in a step S131, a list of registered situation keywords is displayed in the display unit 112. When the user selects the displayed keywords, in a step S132, search is executed in the management data storing unit 129 to extract all images having the selected situation keywords. Then, in a step S133, thumbnail images of the extracted images are displayed as a retrieving result list.

FIG. 32 is a flowchart showing a rough image retrieving process based on images.

In a step S136, when the user selects an image file from the image storing unit 127, and instructs retrieval of images similar to the image, in a step S137, situation keywords correlated with the selected image are all extracted from the management data storing unit 129.

Next, search is executed in the management data storing unit 129 to extract all images having the selected situation keywords. Then, in a step S139, thumbnail images of the extracted images are displayed as a retrieving result list.

According to the image retrieving method of the third embodiment, each image is displayed in a feature space based on image information of a photographing time which accompanies the image, e.g., Exif information, and a distribution range of a preselected sample image is decided by using Mahalanobis' distance. Then, the distribution range of the preselected sample image is registered together with its situation keyword in the keyword storing unit. Next, determination is made as to whether each Exif information of all the images to be managed is within this distribution range or not. Then, the situation keyword is registered in the management data storing unit of the image determined to be within the range.

The list of the situation keywords registered in the keyword storing unit is displayed. Search is executed in the management data storing unit by using the selected situation keywords as keys, and the list of retrieving results is displayed.

An image file is selected from the image storing unit, situation keywords registered in the management data storing unit of the selected image are extracted. By using these situation keys as keys, search is executed in the management data storing unit, and the list of retrieving results is displayed.

Furthermore, when Exif information input at the time of inputting image data from the camera or the like is extracted, and determination is made as to whether it is within the distribution range of each keyword of the keyword storing unit or not, the situation keyword is registered in the management data storing unit.

With the foregoing configuration, images accurately photographed in a photographing situation desired by a retriever including an image to which no keyword is added or with which no keyword is correlated based on human's subjective view of image data itself can be extracted as retrieving results.

A situation keyword indicating a photographing situation of each image is accurately added in the management data storing unit of the image input into the apparatus by the image input means without any addition by a human. Thus, it is not necessary for the human to add any new keywords.

Accordingly, it is possible to carry out retrieval more easily understood by the retriever than retrieval of a value of photographic information contained in image data directly as retrieving conditions.

According to the embodiment, the distribution range of the preselected sample image is calculated by using the Mahalanobis' distance. However, the method of calculating a distribution range is not limited to the Mahalanobis' distance. A distribution range may be decided based on each index defined based on a statistical method, e.g., an average value, a variance, maximum and minimum values or the like.

Each function of the embodiment may be configured by using hardware, or realized by causing a computer to read a program which describes each function by using software. Additionally, each function may be configured by properly selecting software or hardware.

Furthermore, each function can be realized by causing a computer to read a program stored in a recording medium (not shown). Here, the recording medium of the embodiment can employ any recording form as long as a program can be recorded and read by the computer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. An image retrieving apparatus comprising:
an image memory which stores image data of an image photographed by a photographing device and photographic information of the image;
an image selection unit which selects image data from the image memory;
a photographic information classification unit which classifies the photographic information corresponding to the image data selected by the image selection unit in accordance with a predetermined classification standard;
an image classification unit which classifies the image data stored in the image memory based on the photographic information classified by the photographic information classification unit;
a keyword addition unit which adds keyword to the image data classified by the image classification unit; and
a retrieval unit which retrieves desired image data based on the keywords added by the keyword addition unit.

2. The apparatus according to claim 1, wherein:
the photographic information classification unit comprises a calculation unit which calculates a distribution range of the photographic information corresponding to each image data selected by the image selection unit, and a range deciding unit which creates a classification standard based on a result of calculation by the calculation unit, and decides a range of a value of the photographic information by the classification standard,
the image classification unit comprises a keyword relating unit which relates a keyword with a classification range that is the range of the value of the photographic information specified by the classification standard, and a keyword memory which stores the keyword and the classification range of the value of the photographic information related with the keyword, and
the keyword addition unit adds a keyword corresponding to the classification range to image data in which the value of the photographic information is determined to be within the classification range corresponding to the keyword.

3. The apparatus according to claim 2, wherein:
the retrieval unit comprises a keyword display unit which displays a list of keywords stored in the keyword memory on a display, and a keyword selection unit which selects the keyword displayed on the display, and
the retrieval unit retrieves image data to which the keyword selected by the keyword selection unit has been added.

4. The apparatus according to claim 2, wherein:
the retrieval unit comprises a second image selection unit which selects the image data stored in the image memory, and a keyword specifying unit which specifies a keyword added to the image data selected by the second image selection unit, and
the retrieval unit retrieves image data to which the same keyword as that specified by the keyword specifying unit has been added.

5. The apparatus according to claim 2, further comprising an image input unit which reads image data,
wherein the keyword addition unit adds a keyword to the image data each time the image input unit reads the image data.

6. The apparatus according to claim 1,
wherein the photographic information is information stored in an image file of an Exif form containing image data.

7. The apparatus according to claim 1, further comprising:
a display having first and second display areas;
a keyword display unit which displays a keyword list constituted of a plurality of keywords in the first display area of the display;
a classified item display unit which displays classified items of the image data in the second display area;
a selection unit which selects the classified items displayed in the second display area;
a keyword selection unit which selects keywords from the keyword list displayed in the first display area;
a related information memory which relates the keywords selected by the keyword selection unit to the image data belonging to the classified items selected by the selection unit, and stores the related information; and
a retrieving result display unit which displays index images of the image data retrieved by the retrieval unit and related to the keywords selected by the keyword selection unit in the second display area based on the related information stored in the related information memory.

8. The apparatus according to claim 7, wherein:
the photographic information classification unit classifies photographing time information contained in the photographic information by year, month and day classification standards, and
the classified item display unit displays the photographing time information by a unit of a photographing day, month or year.

9. The apparatus according to claim 7, further comprising:
a related information deletion unit which deletes the related information between the image data corresponding to the index images retrieved by the retrieval unit or the image data belonging to the classified items selected by the selection unit and the keywords selected by the keyword selection unit.

10. The apparatus according to claim 1, further comprising:
a display having first and second display areas;
a keyword display unit which displays a keyword list constituted of a plurality of keywords in the first display area of the display;
an image information display unit which displays index images of image data stored in the image memory or the classified items of the image data in the second display area;
a selection unit which selects the index images or the classified items displayed in the second display area;
a keyword selection unit which selects first keywords from the keyword list displayed in the first display area;
a related information memory which relates the first keywords selected by the keyword selection unit to the image data corresponding to the index images selected by the selection unit or the image data belonging to the classified items selected by the selection unit, and stores the related information;
a retrieved keyword selection unit which selects second keywords from the keyword list; and
a retrieving result display unit which displays the index images of the image data retrieved by the retrieval unit and related to the second keywords selected by the retrieved keyword selection unit in the second display area based on the related information stored in the related information memory.

11. An image retrieving method of an image retrieving apparatus which has an image memory to store image data of an image photographed by a photographing device and photographic information of the image, and retrieves desired image data from the image memory, comprising:
selecting a plurality of image data from the image memory;
classifying the photographic information corresponding to the selected image data in accordance with a predetermined classification standard;
classifying the image data stored in the image memory based on the photographic information classified by the classification standard;
adding keywords to the classified image data; and
retrieving desired image data based on the added keywords.

12. The method according to claim 11, wherein
classifying the photographic information in accordance with the predetermined classification standard includes:
calculating a distribution range of the photographic information corresponding to each selected image data, and creating a classification standard based on a result of calculation to decide a range of a value of the photographic information in accordance with the classification standard,
classifying the image data stored in the image memory based on the photographic information classified by the classification standard includes:
relating a keyword with a classification range that is the range of the value of the photographic information specified by the classification standard, and storing the keyword and the classification range of the value of the photographic information related with the keyword, and
adding the keywords to the classified image data includes adding a keyword corresponding to the classification range to image data in which the value of the photographic information is determined to be within the classification range corresponding to the keyword.

13. The method according to claim 12, wherein
retrieving the image data based on the added keywords includes:
displaying a list of keywords stored in the keyword memory on a display,
selecting the keyword displayed on the display, and
retrieving image data to which the selected keyword has been added.

14. The method according to claim 12, wherein
retrieving the image data based on the added keywords includes:
selecting the image data stored in the image memory,
specifying a keyword added to the selected image data, and
retrieving image data to which the same keyword as the specified keyword has been added.

15. The method according to claim 12, further comprising:
adding a keyword to the image data each time the image data is read.

16. The method according to claim 11,
wherein the photographic information is information stored in an image file of an Exif form containing image data.

17. The method according to claim 11, further comprising:
displaying a keyword list constituted of a plurality of keywords in a first display area of a display;
displaying classified items of the image data in a second display area of the display;
selecting the classified items displayed in the second display area;
selecting keywords from the keyword list displayed in the first display area;
relating the selected keywords to the image data belonging to the selected classified items to store the related information; and
retrieving index images of the image data related to the selected keywords based on the stored related information to display the index images in the second display area.

18. The method according to claim 17, wherein:
classifying the photographic information corresponding to the selected image data in accordance with the predetermined standard includes classifying photographing time information contained in the photographic information by year, month and day classification standards, and
classifying the image data stored in the image memory based on the classified photographic information includes displaying the photographing time information in accordance with a classification unit of a photographing day, month or year.

19. The method according to claim 17, further comprising:
deleting the related information between the image data corresponding to the retrieved index images or the image data belonging to the selected classified items and the selected keywords.

20. The method according to claim 11, further comprising:
displaying a keyword list constituted of a plurality of keywords in a first display area of a display;
displaying index images of image data stored in the image memory or the classified items of the image data in a second display area of the display;
selecting the index images or the classified items displayed in the second display area;
selecting first keywords from the keyword list displayed in the first display area;
relating the selected first keywords to the image data corresponding to the selected index images or the image data belonging to the selected classified items to store the related information;
selecting second keywords from the keyword list; and
retrieving the index images of the image data related to the selected second keywords based on the stored related information to display the index images in the second display area.

21. A program executed in an image retrieving apparatus which has an image memory to store image data of an image photographed by a photographing device and photographic information of the image data, and retrieves desired image data from the image memory, causing a computer to execute:
an image selection step of selecting a plurality of image data from the image memory;
a photographic information classification step of classifying the photographic information corresponding to the image data selected in the image selection step in accordance with a predetermined classification standard;
an image classification step of classifying the image data stored in the image memory based on the photographic information classified in the photographic information classification step;
a keyword addition step of adding keywords to the image data classified in the image classification step; and
a retrieval step of retrieving the image data based on the keywords added in the keyword addition step.

22. The program according to claim 21, wherein:
the photographic information classification step comprises a calculation step of calculating a distribution range of the photographic information corresponding to each image data selected in the image selection step, and a range deciding step of creating a classification standard based on a result of calculation in the calculation step, and deciding a range of a value of the photographic information by the classification standard,
the image classification step comprises a keyword relating step of relating a keyword with a classification range that is the range of the value of the photographic information specified by the classification standard, and a keyword storing step of storing the keyword and the classification range of the value of the photographic information correlated with the keyword, and
the keyword addition step of adding a keyword corresponding to the classification range to image data in which the value of the photographic information is determined to be within the classification range corresponding to the keyword.

23. The program according to claim 22, wherein:
the retrieval step comprises a keyword display step of displaying a list of keywords stored in the keyword memory on a display, and a keyword selection step of selecting the keyword displayed on the display, and
image data to which the keyword selected in the keyword selection step has been added is retrieved.

24. The program according to claim 22, wherein:
the retrieval step comprises a second image selection step of selecting the image data stored in the image memory, and a keyword specifying step of specifying a keyword added to the image data selected in the second image selection step, and
image data to which the same keyword as that specified by the keyword specifying step has been added is retrieved.

25. The program according to claim 22, further comprising an image input step,
wherein a keyword is added to the image data each time the image input step reads the image data in the keyword addition step.

26. The program according to claim 21,
wherein the photographic information is information stored in an image file of an Exif form containing image data.

27. The program according to claim 21, further comprising:
a keyword display step of displaying a keyword list constituted of a plurality of keywords in a first display area of a display;
a classified item display step of displaying classified items of the image data in a second display area of the display;
a selection step of selecting the classified items displayed in the second display area;
a keyword selection step of selecting keywords from the keyword list displayed in the first display area;
a related information storing step of relating the keywords selected in the keyword selection step to the image data belonging to the classified items selected in the selection step, and storing the related information; and
a retrieving result display step of displaying index images of the image data retrieved in the retrieval step and related to the keywords selected in the keyword selection step in the second display area based on the related information stored in the related information storing step.

28. The program according to claim 27, wherein:
photographing time information contained in the photographic information by year, month and day classification standards is classified in the photographic information classification step, and
the photographing time information by a unit of a photographing day, month or year is displayed in the classified item display step.

29. The program according to claim 27, further comprising:
a related information deletion step of deleting the related information between the image data corresponding to the index images retrieved in the retrieval step or the image data belonging to the classified items selected in the selection step and the keywords selected in the keyword selection step.

30. The program according to claim 21, further comprising:
a keyword display step of displaying a keyword list constituted of a plurality of keywords in a first display area of a display;
an image information display step of displaying index images of image data stored in the image memory or the classified items of the image data in the second display area of the display;
a selection step of selecting the index images or the classified items displayed in the second display area;
a keyword selection step of selecting first keywords from the keyword list displayed in the first display area;
a related information storing step of relating the first keywords selected in the keyword selection step to the image data corresponding to the index images selected in the selection step or the image data belonging to the classified items selected in the selection step, and storing the related information;
a retrieved second keyword selection step of selecting keywords from the keyword list; and
a retrieving result display step of displaying the index images of the image data retrieved in the retrieval step and related to the second keywords selected in the keyword selection step in the second display area based on the related information stored in the related information storing step.
